(19) United States
(12) Patent Application Publication
(10) Pub. No.: US 2026/0319235 A1
(43) Pub. Date: Oct. 15, 2026

(54) MICROSCOPE

(71) Applicant: CANON KABUSHIKI KAISHA, Tokyo (JP)

(72) Inventor: MITSUHIRO IKUTA, Kanagawa (JP)

(21) Appl. No.: 19/684,542

(22) Filed: May 21, 2026

Related U.S. Application Data
(63) Continuation of application No. PCT/JP2024/041334, filed on Nov. 21, 2024.

(30) Foreign Application Priority Data
Nov. 30, 2023 (JP) 2023-202724

(51) Int. Cl. G02B 21/00; G02B 21/14

(52) U.S. Cl. CPC G02B 21/0032; G02B 21/14

(57) ABSTRACT

A microscope includes an optical system for phase-contrast observation and an optical system for nonlinear optical observation that are arranged to face each other with an object therebetween, a ring stop that functions as a stop for primary light for the phase-contrast observation and transmits secondary light including a nonlinear optical effect of the object, and a phase ring arranged at a position optically conjugate to the ring stop.

### CROSS-REFERENCE TO RELATED APPLICATIONS

This application is a Continuation of International Patent Application No. PCT/JP2024/041334, filed Nov. 21, 2024, which claims the benefit of Japanese Patent Application No. 2023-202724, filed Nov. 30, 2023, both of which are hereby incorporated by reference herein in their entirety.

### BACKGROUND

### Field of the Technology

The present disclosure relates to a microscope.

### Description of the Related Art

A phase-contrast observation method is known as a method for observing a form of a specimen, such as a cell, for which a contrast is difficult to visually recognize in a bright-field observation method. In the phase-contrast observation method, an annular stop (a ring stop) that partially blocks illumination is arranged at a pupil position of a condenser, and an annular phase plate (a phase ring) that is conjugate with the annular stop is arranged at a pupil position of an objective lens.

A method is known in which a distribution of molecular vibrations and the like contained in a specimen is acquired by using a nonlinear optical effect to detect scattered light including a nonlinear response of the specimen with respect to an intensity of irradiation light. Examples using a nonlinear optical effect include multiphoton excitation fluorescence, second-harmonic generation, coherent anti-Stokes Raman scattering, and stimulated Raman scattering.

A microscope that combines these methods and has an optical system that shares a part of an illumination optical path and a part of a detection optical path before and after a specimen is described in, for example, Japanese Patent Laid-Open No. 2019-35859.

When an optical path of a phase-contrast observation method and an optical path of an observation method using a nonlinear optical effect (below, a nonlinear optical observation method) are shared before and after a specimen, illumination light or scattered light of the nonlinear optical observation method is blocked by a stop used in the phase-contrast observation method, thereby reducing a signal amount and reducing efficiency. To solve this issue, Japanese Patent Laid-Open No. 2019-35859 describes a technique of forming, by using a relay optical system, a position conjugate with a pupil of a condenser, arranging a stop at the position, and branching the optical path into an optical path of the phase-contrast observation method and an optical path of the nonlinear optical observation method between a specimen and the stop. However, the relay optical system increases a size of the optical system.

### SUMMARY

The present disclosure is directed to providing a microscope including a compact optical system that can simultaneously acquire a phase-contrast image obtained by a phase-contrast method and a nonlinear optical image obtained by a nonlinear optical method.

A microscope according to some embodiments of the present disclosure includes a placement unit (e.g., a placement system or placement support) on which an object is placed, a first optical system including a first condensing lens that condenses first light emitted from a first light source and irradiates the object with first irradiation light, a first detection unit (e.g., a detector) that is located on an opposite side of the placement unit from the first optical system and detects, via a second condensing lens that is arranged to face the first condensing lens with the placement unit between the second condensing lens and the first condensing lens, first emitted light including a first wavelength and emitted from the object by a nonlinear optical effect of the first irradiation light, a second optical system that includes the second condensing lens arranged to face the first condensing lens on an opposite side from the first condensing lens and irradiates the object with second irradiation light including a second wavelength different from the first wavelength and emitted from a second light source, and a second detection unit (e.g., a detector) that detects, via the first condensing lens, second emitted light emitted from the object by the second irradiation light. The first optical system includes a first separation unit (e.g., a first separator or a first separation assembly) that transmits one of the first light and the second emitted light and reflects the other of the first light and the second emitted light. The second optical system includes a second separation unit (e.g., a second separator or a second separation assembly) that transmits one of second light and the first emitted light and reflects the other of the second light and the first emitted light, and a first optical member that is arranged between the second separation unit and the second condensing lens, has a higher spectral transmittance at the first wavelength than at the second wavelength, and attenuates a part of the second light. The microscope further includes a second optical member that is arranged between the second detection unit and the first condensing lens and is arranged at a position optically conjugate to the first optical member.

Features of the present disclosure will become apparent from the following description of embodiments with reference to the attached drawings.

### BRIEF DESCRIPTION OF THE DRAWINGS

FIG. 1 is a diagram illustrating a configuration of a microscope according to some embodiments.

FIG. 2 is a diagram illustrating a configuration of a first light source and a scanning unit according to some embodiments.

FIG. 3 is a diagram illustrating a configuration of a microscope according to some embodiments.

FIG. 4 is a diagram illustrating a configuration of a microscope according to some embodiments.

### DESCRIPTION OF THE EMBODIMENTS

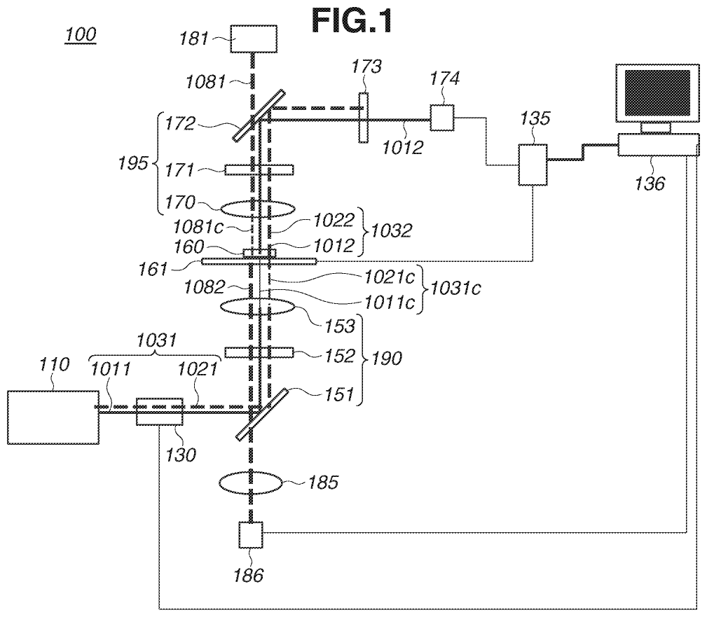

A microscope 100 according to some embodiments is a multimodal microscope that can acquire, in a common region of interest of a common specimen, a physical property image including stimulated Raman scattering light so that an observer can use a nonlinear optical observation method, together with a morphological image obtained by a phase-contrast observation method. The nonlinear optical observation method provided by the microscope of the present embodiments can also be applied to nonlinear optical scattering other than stimulated Raman scattering. The nonlinear optical scattering other than stimulated Raman scattering includes multiphoton excitation fluorescence, second-harmonic generation light, coherent anti-Stokes Raman scattering light, and the like. FIG. 1 is a diagram illustrating a schematic configuration of the microscope 100 according to some embodiments. Examples of the physical property image provided by the microscope 100 according to the present embodiments include a molecular vibration spectrum image in an object and a distribution of interatomic bonds, and examples of an object include an organic material and a biological material.

### 1-1 Nonlinear Optical Light Detection System

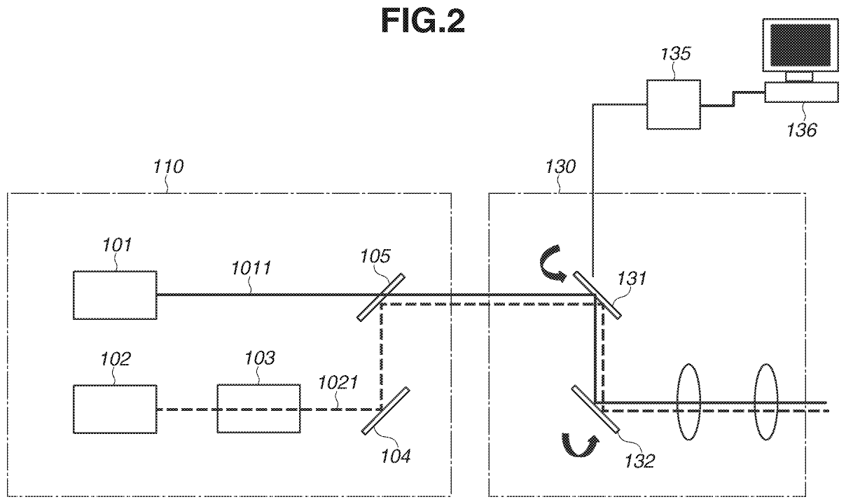

A first light source of a nonlinear optical detection system of the microscope 100 according to some embodiments will be described with reference to FIG. 2.

A first light source 110 includes an excitation light source 101 that emits excitation light 1011, and a dichroic mirror 105 that transmits the excitation light 1011 in a wavelength-selective manner. Pulsed light is employed as the excitation light 1011 to efficiently generate a nonlinear optical process. A pulse width of the excitation light 1011 as pulsed light can be on the order of femtoseconds to picoseconds. A pulse repetition frequency can be 1 MHz or more from a viewpoint of reducing an influence of intensity fluctuation of the excitation light 1011. When a titanium-sapphire laser oscillating in a near-infrared band is employed as the excitation light source 101, a wavelength of the excitation light 1011 is set between 700 nanometers (nm) and 1000 nm.

Next, a probe light source 102 included in the first light source 110 will be described. The probe light source 102 emits probe light 1021. The probe light 1021 is pulsed light, and a pulse width of the probe light 1021 can be on the order of femtoseconds to picoseconds. A wavelength of the probe light 1021 is set to be different from a wavelength of the excitation light 1011, and is desirably set to differ by approximately a wavelength corresponding to a Raman shift (a wavenumber) of molecular information about an object. When a titanium-sapphire laser is employed as the excitation light source 101, the probe light source 102 that can sweep the wavelength of the probe light 1021 between 1000 nm and 1100 nm can be employed. Examples of the probe light source 102 include an optical fiber laser such as a Yb fiber laser or an Er fiber laser. In addition, when a pulse repetition frequency of the probe light 1021 is set to one-half of the pulse repetition frequency of the excitation light 1011, the nonlinear optical effect of an object allows signal light 1012 to be modulated at the same frequency as the pulse repetition frequency of the probe light 1021. Alternatively, by matching the pulse repetition frequency of the excitation light 1011 and the pulse repetition frequency of the probe light 1021, intensity modulation may be applied to the excitation light 1011 or the probe light 1021.

The probe light 1021 passes through an optical delay system 103 and a mirror 104, is reflected by the dichroic mirror 105, and is combined coaxially with the excitation light 1011. When the excitation light 1011 and the probe light 1021 are combined by the dichroic mirror 105, an optical path length of the probe light 1021 is adjusted by using the optical delay system 103 so that pulses of the excitation light 1011 and pulses of the probe light 1021 coincide in time.

A scanning unit 130 (e.g., a scanner or a scanning assembly) for scanning, on an object 160, first irradiation light 1031c obtained by further condensing, with a condensing lens, first light 1031 including the excitation light 1011 and the probe light 1021 from the first light source 110 will be described.

The scanning unit 130 includes a pair of scanning mirrors 131 and 132 that is configured to be angularly displaced in two directions orthogonal to a traveling direction of each of excitation light 1011 and probe light 1021. As the pair of scanning mirrors 131 and 132, a galvano scanner, a resonant scanner, or a polygon scanner can be employed for each of them. Each of the scanning mirrors 131 and 132 is configured to be controlled by a control unit 135 (e.g., a controller) and to output angular displacement information to the control unit 135.

A first optical system 190 of a nonlinear optical observation system of the microscope 100 according to some embodiments will be described with reference to FIG. 1.

As illustrated in FIG. 1, the first light 1031 (the excitation light 1011 and the probe light 1021) that is angularly displaced is reflected by a first separation unit 151 (e.g., a first separation assembly or a dichroic mirror) and passes through a second optical member 152 (a phase ring). The first light 1031 (the excitation light 1011 and the probe light 1021) incident on a first condensing lens 153 via the second optical member 152 (the phase ring) is condensed by the first condensing lens 153 toward the object 160 placed on a placement unit 161 (e.g., a placement system or placement support).

By providing a movable stage (not illustrated) coupled to the placement unit 161, the movable stage can move the object 160 via the placement unit 161 in an optical axis direction of the first light 1031 (the excitation light 1011 and the probe light 1021) and a direction intersecting the optical axis direction. The placement unit 161 and the control unit 135 are configured to be communicably connected and the placement unit 161 is configured to output its position information to the control unit 135, whereby the control unit 135 can move the placement unit 161 via the movable stage.

Next, a second optical system 195 of the nonlinear optical observation system of the microscope 100 according to some embodiments will be described with reference to FIG. 1.

When a Raman shift caused by molecular vibrations contained in the object 160 matches a difference in wavenumber between the excitation light 1011 and the probe light 1021, an intensity of the excitation light 1011 slightly decreases and an intensity of the probe light 1021 slightly increases due to a stimulated Raman scattering effect.

Hereafter, an example in which emitted light 1012 (secondary light) included in first emitted light 1032 modulated by the stimulated Raman scattering effect and having the same wavelength as the excitation light 1011 is used as the signal light 1012 will be described as the microscope 100. Meanwhile, the present disclosure also includes an unillustrated modification in which emitted light 1022 (secondary light) included in the first emitted light 1032 and having the same wavelength as the probe light 1021 is used as signal light 1022.

The excitation light 1011 and the signal light 1012 that are included in the first emitted light 1032 generated by a nonlinear optical effect travel as parallel light having angular displacement due to a second condensing lens 170. The signal light 1012 passes through a first optical member 171 (a ring stop) and is reflected by a second separation unit 172 (a dichroic mirror) in a wavelength-selective manner.

The emitted light 1012 (secondary light) reflected by the second separation unit 172 (the dichroic mirror) passes through a spectral filter 173 that attenuates a wavelength of the probe light 1021 and selectively transmits a wavelength of the excitation light 1011, and the emitted light 1012 is then guided to a first detection unit 174. The emitted light 1012 is detected as the signal light 1012 by the first detection unit 174.

The first detection unit 174 (e.g., a first detector) outputs a detection signal to the control unit 135. Angular displacement information about the pair of scanning mirrors 131 and 132 and the detection signal are analyzed in a computer 136 to generate an image. By combining the analysis with scanning, which is performed while moving the placement unit 161 in the optical axis direction under control of the control unit 135, a three-dimensional physical property image of the object 160 can be acquired.

For an output signal from the first detection unit 174, high-sensitivity detection may also be performed by performing lock-in detection of the signal light 1012 (the emitted light 1012) by a lock-in amplifier (not illustrated) using, as a reference input, a pulse repetition frequency signal of the probe light 1021.

The first detection unit 174 is located on an opposite side of the placement unit 161 from the first optical system 190. The first detection unit 174 is configured to detect, via the second condensing lens 170, the first emitted light 1032 including a first wavelength λ1 emitted from the object 160 due to a nonlinear optical effect of the first irradiation light 1031c. The second condensing lens 170 is arranged to face the first condensing lens 153 with the placement unit 161 therebetween.

### 1-2 Phase-Contrast Detection System

A phase-contrast detection system of the microscope 100 according to some embodiments will be described with reference to FIG. 1.

As illustrated in FIG. 1, the phase-contrast detection system includes a second light source 181 that emits second light 1081 having a second wavelength, and a second optical system 195 including a plurality of optical elements between the second light source 181 and the placement unit 161.

The second optical system 195 includes the second separation unit 172 (the dichroic mirror) that is optically coupled to the second light source 181 and transmits the second light 1081 in a wavelength-selective manner. The second optical system 195 further includes the first optical member 171 (the ring stop) that partially blocks a light flux of the second light 1081 having transmitted through the second separation unit 172, and the second condensing lens 170 that condenses the light flux of the second light 1081 and irradiates the object 160 with the second light 1081.

By employing a white light-emitting diode (LED) or a lamp including a plurality of emission wavelengths as the second light source 181, a wavelength band of the second light 1081 can be a visible-light band. The second light source 181 may be a monochromatic light source by including a wavelength-selection filter. A wavelength of the second light 1081 is desirably set to be different from a wavelength of the excitation light 1011 and a wavelength of the probe light 1021, and can be set to, for example, a value ranging from 450 nm to 650 nm, which is shorter than the wavelengths of the excitation light 1011 and the probe light 1021.

Between the second light source 181 and the second separation unit 172 (the dichroic mirror), an element such as a lens (not illustrated) is arranged so that the second light 1081 forms Köhler illumination by the second condensing lens 170. The first optical member 171 (the ring stop) is arranged at a pupil position of the second condensing lens 170, so that a light flux of the second light 1081 is partially blocked and a remaining portion of the light flux is transmitted. The first optical member 171 (the ring stop) includes a predetermined transmission region, but the first optical member 171 is not necessarily annular.

Second irradiation light 1081c obtained by condensing the remaining portion of the light flux of the second light 1081 irradiates the object 160, and a portion of the second irradiation light 1081c is diffracted by the object 160. The second irradiation light 1081c may be referred to as illumination light 1081c or second illumination light 1081c. Second emitted light 1082 corresponding to transmitted light that includes scattered light and diffracted light and that transmits through the object 160 is guided to transmit through the first condensing lens 153. The second emitted light 1082 guided via the first condensing lens 153 passes through the second optical member 152 (the phase ring). The second optical member 152 (the phase ring) is in an optically conjugate relationship with the first optical member 171 (the ring stop) via the first condensing lens 153 and the second condensing lens 170. To obtain the optically conjugate relationship between the first optical member 171 (the ring stop) and the second optical member 152 (the phase ring), a position adjustment mechanism may be provided for at least one of the first optical member 171 and the second optical member 152.

The second optical member 152 (the phase ring) includes a phase plate having a shape corresponding to the shape of the first optical member 171 (the ring stop), and an attenuation filter. The second emitted light 1082 having passed through the second optical member 152 transmits through the first separation unit 151 (the dichroic mirror), and an image of the second emitted light 1082 is formed on a sensor surface of the second detection unit 186 via an imaging lens 185. The second detection unit 186 can obtain a phase-contrast image corresponding to a distribution of a refractive index of the object 160. The phase-contrast image may be referred to as a morphological image.

### 1-3 First Optical Member (Ring Stop)

Next, the first optical member 171 (the ring stop), which characterizes the microscope 100 of some embodiments, will be described with reference to FIG. 1.

The first optical member 171 (the ring stop) has spectral transmittance characteristics and is configured to block a portion of the second light 1081 so as to function as a stop for the second light 1081 and transmit the signal light 1012 included in the first emitted light 1032 without functioning as a stop for the signal light 1012. With the first optical member 171 being optically positioned and having spectral transmittance as described above, a signal intensity of nonlinear optical observation is maintained, and nonlinear optical observation and phase-contrast observation can be simultaneously performed.

In a region through which the light flux of the second light 1081 passes, at least a part of the first optical member 171 (the ring stop) is made of a material having wavelength-selective transmittance. For example, in a case where the second light 1081 is visible light and the signal light 1012 included in the first emitted light 1032 is near-infrared light, the first optical member 171 (the ring stop) can be made of a material having an absorption coefficient for visible light higher than an absorption coefficient for near-infrared light.

The first optical member 171 can be configured such that a ring-shaped dielectric multilayer film structure is formed on a substrate made of transparent glass and a reflectance for visible light is higher than a reflectance for near-infrared light.

The first optical member 171 (the ring stop) can be further configured such that a transmittance of at least a part of the first optical member 171 is a predetermined spectral transmittance, similarly to the filter 173. Specifically, a spectral transmittance of a part of the first optical member 171 (the ring stop) is configured to be higher for the excitation light 1011 and the second light 1081 than for the probe light 1021. With this configuration, the first detection unit 174 can detect the signal light 1012 included in the first emitted light 1032 and having a wavelength corresponding to the wavelength of the excitation light 1011. For example, the ring stop can be formed by perforating, into a ring shape, a band-pass filter that transmits light having a wavelength corresponding to the wavelength of the excitation light 1011.

The excitation light 1011 included in the first light 1031 emitted from the first light source 110 can be regarded as exhibiting a first wavelength, the second light 1081 emitted from the second light source 181 can be regarded as exhibiting a second wavelength, and the probe light 1021 included in the first light 1031 emitted from the first light source 110 can be regarded as exhibiting a third wavelength.

In this case, as described above, the first wavelength of the excitation light 1011 is longer than the second wavelength of the second light 1081. The first light source 110 can be described as being configured to emit third light (probe light 1021) having the third wavelength that is different from both the first wavelength corresponding to the excitation light 1011 and the second wavelength corresponding to the second light 1081. The first wavelength can be set to be longer than the third wavelength.

The first separation unit 151 (the dichroic mirror) is an element included in the first optical system 190, and the first separation unit 151 can be described as being configured to transmit one of the first light 1031 and the second emitted light 1082 and reflect the other of the first light 1031 and the second emitted light 1082. The first separation unit 151 can also be described as being arranged in a section that is on an optical path of the first light 1031 from the first light source 110 to the first condensing lens 153 and that is also on an optical path of the second emitted light 1082 from the first optical system 190 to the second detection unit 186.

Similarly, the second separation unit 172 (the dichroic mirror) is an element included in the second optical system 195, and the second separation unit 172 can be described as being configured to transmit one of the second light 1081 and the first emitted light 1032 and reflect the other of the second light 1081 and the first emitted light 1032. The second separation unit 172 can also be described as being arranged in a section that is on an optical path of the second light 1081 from the second light source 181 to the second condensing lens 170 and that is also on an optical path of the first emitted light 1032 from the second condensing lens 170 to the first detection unit 174.

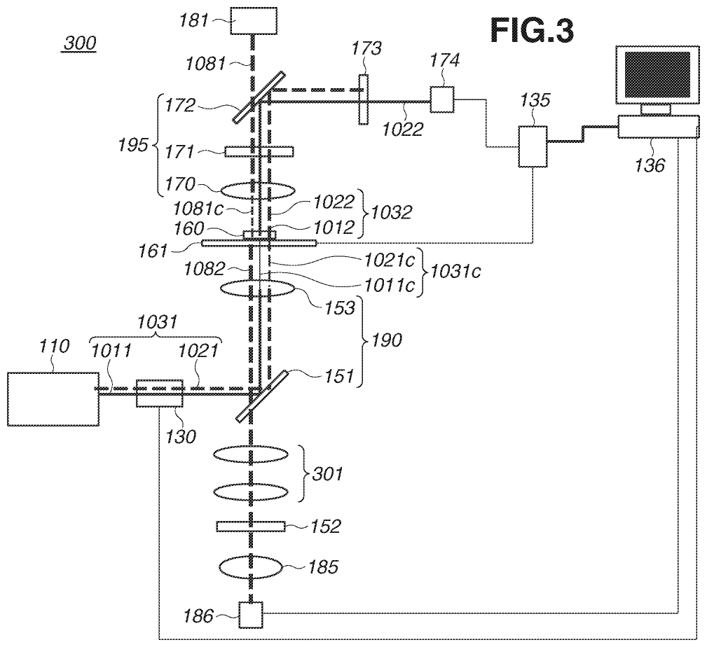

A microscope 300 according to some embodiments will be described with reference to FIG. 3. The microscope 300 according to the present embodiment differs from the microscope 100 as described above for FIG. 1 in a position at which the second optical member 152 (the phase ring) is provided and in that the microscope 300 includes a relay optical system 301.

A relay optical system 301 includes a pair of lenses and is configured to relay a position optically conjugate to the first optical member 171 (a ring stop) to a location between the first separation unit 151 (a dichroic mirror) and the imaging lens 185. The position optically conjugate to the first optical member 171 corresponds to the position at which the second optical member 152 (a phase ring) is provided as described above.

In some embodiments, the second optical member 152 (the phase ring) is arranged at the position optically conjugate to the first optical member 171 (the ring stop), which is formed by the relay optical system 301. As a result, the excitation light 1011 and the probe light 1021 do not pass through the second optical member 152 (the phase ring), thereby improving a degree of freedom in designing the second optical member 152. For example, even when a material that absorbs the excitation light 1011 or the probe light 1021 is used for the second optical member 152 (the phase ring), the arrangement of the second optical member 152 (the phase ring) provides an advantage that nonlinear optical observation is not affected. In addition, even when an optical intensity of the excitation light 1011 or the probe light 1021 included in the first light 1031 is increased, the arrangement of the second optical member 152 (the phase ring) provides another advantage that the second optical member 152 (the phase ring) is less likely to be thermally damaged.

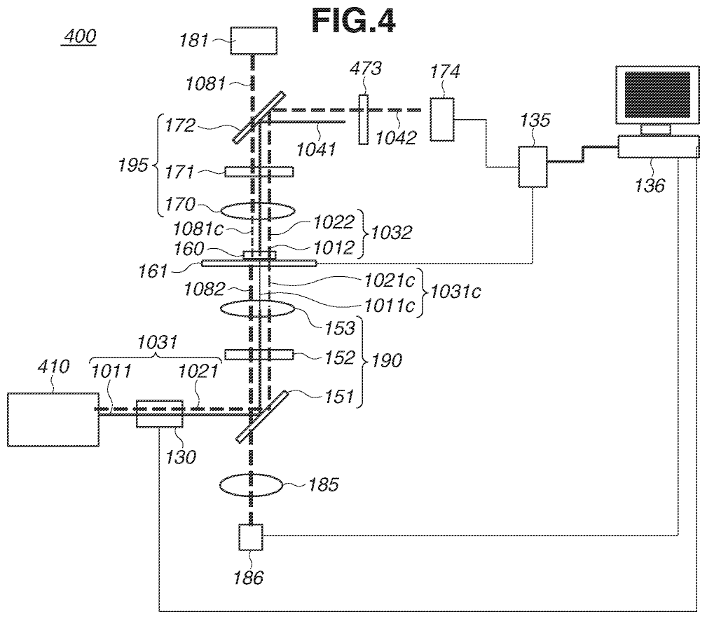

A microscope 400 will be described with reference to FIG. 4. The microscope 400 shown in FIG. 4 differs from the microscope 100 shown in FIG. 1 in that, to use two-photon excitation fluorescence as nonlinear optical observation, the microscope 400 uses a two-photon excitation light source 410 instead of the first light source 110.

Excitation light 1041 is emitted from the excitation light source 410 and angularly displaced by the scanning unit 130 in two directions orthogonal to a traveling direction of the excitation light 1041. As the excitation light source 410, a titanium-sapphire laser that emits femtosecond pulsed light having an emission wavelength set to a predetermined wavelength from 800 nm to 1100 nm is employed.

The excitation light 1041 is emitted onto the object 160 along a path similar to the path of the excitation light 1011 of the microscope 100 described in FIG. 1. The object 160 is excited by two-photon absorption, and signal light 1042 that is fluorescence of the object 160 is detected by the first detection unit 174 on a path similar to the path of the signal light 1012 included in the first emitted light 1032 in FIGS. 1 and 2. A spectral filter 473 is arranged on the path and blocks the excitation light 1041 component that transmits through the object 160. An output signal of the first detection unit 174 is transmitted to the control unit 135. Angular displacement information about the pair of scanning mirrors 131 and 132 and the output signal are analyzed in the computer 136 to generate an image. By moving the placement unit 161 in the optical axis direction and combining the analysis with position information about the placement unit 161, a three-dimensional image of the object 160 can be constructed.

The microscope 400 includes an optical system for phase-contrast observation similar to the optical system described in FIGS. 1-3. The first optical member 171 (the ring stop) is configured to block a portion of the second light 1081 so as to function as a stop for the second light 1081 and transmit the signal light 1042 so as not to function as a stop for the signal light 1042. As a result, a signal intensity of nonlinear optical observation is maintained, and nonlinear optical observation and phase-contrast observation can be performed simultaneously. A wavelength of the second light 1081 is desirably selected to be different from a wavelength of the signal light 1042.

The present disclosure is not limited to the above embodiments, and various changes and modifications can be made without departing from the spirit and scope of the present disclosure. Accordingly, the following claims are appended to disclose the scope of the present disclosure.

According to an embodiment of the present disclosure, a microscope including a compact optical system that can simultaneously acquire a phase-contrast image obtained by a phase-contrast method and a nonlinear optical image obtained by a nonlinear optical method can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A microscope comprising:
a placement unit on which an object is placed;
a first optical system including a first condensing lens configured to condense a first light emitted from a first light source and irradiate the object with a first irradiation light;
a first detection unit located on an opposite side of the placement unit from the first optical system, the first detection unit being configured to detect, via a second condensing lens arranged to face the first condensing lens with the placement unit between the second condensing lens and the first condensing lens, a first emitted light including a first wavelength emitted from the object by a nonlinear optical effect of the first irradiation light;
a second optical system including the second condensing lens arranged to face the first condensing lens on an opposite side of the first condensing lens, the second optical system being configured to irradiate the object with a second irradiation light including a second wavelength different from the first wavelength that is obtained from condensing a second light emitted from a second light source;
a second detection unit configured to detect, via the first condensing lens, a second emitted light emitted from the object after incidence of the second irradiation light;
wherein the first optical system includes a first separation unit configured to transmit one of the first light and the second emitted light and reflect the other of the first light and the second emitted light;
wherein the second optical system includes a second separation unit configured to transmit one of the second light and the first emitted light and reflect the other of the second light and the first emitted light, and a first optical member arranged between the second separation unit and the second condensing lens, the first optical member having a spectral transmittance at the first wavelength higher than a spectral transmittance at the second wavelength and being configured to attenuate a part of the second light; and
a second optical member arranged between the second detection unit and the first condensing lens and arranged at a position optically conjugate to the first optical member.

2. The microscope according to claim 1, wherein the first wavelength is longer than the second wavelength.

3. The microscope according to claim 1, wherein the first light source is configured to emit third light including a third wavelength different from the first wavelength and the second wavelength.

4. The microscope according to claim 3, wherein the first wavelength is shorter than the third wavelength.

5. The microscope according to claim 3, wherein the first optical member has a spectral transmittance at the third wavelength that is lower than the spectral transmittance at the first wavelength.

6. The microscope according to claim 1, wherein the second optical member includes a phase plate having a shape conjugate to a shape of the first optical member.

7. The microscope according to claim 1, wherein the second optical member is arranged between the first separation unit and the second detection unit.

8. The microscope according to claim 1, wherein the second optical member is arranged between the first condensing lens and the first separation unit.

9. The microscope according to claim 1, wherein the second optical member is arranged between the first separation unit and the second detection unit.

10. The microscope according to claim 1, further comprising a scanning unit configured to scan a position of a light flux of the first light, the scanning unit being arranged between the first light source and the second separation unit.

11. The microscope according to claim 1, wherein the first separation unit is arranged in a section that is on an optical path of the first light from the first light source to the first condensing lens and that is also on an optical path of the second emitted light from the first optical system to the second detection unit.

12. The microscope according to claim 1, wherein the second separation unit is arranged in a section that is on an optical path of the second light from the second light source to the second condensing lens and that is also on an optical path of the first emitted light from the second condensing lens to the first detection unit.

13. The microscope according to claim 1, further comprising the first light source.

14. The microscope according to claim 1, further comprising the second light source.
